(19) United States
(12) Patent Application Publication
(10) Pub. No.: US 2010/0194129 A1
(43) Pub. Date: Aug. 5, 2010

(54) SEPARATOR FOR PULLING OFF STACKED PACKAGING SHEETS WITH EMBOSSED CAVITIES

(75) Inventor: Michel Bouthiette, Granby (CA)

Correspondence Address: DARBY & DARBY P.C., P.O. BOX 770, Church Street Station, New York, NY, 10008-0770, US

(73) Assignee: 9155-0020 QUEBEC INC., Granby (CA)

(21) Appl. No.: 12/419,520

(22) Filed: Apr. 7, 2009

(30) Foreign Application Priority Data
Feb. 3, 2009 (CA) 2652791

(51) Int. Cl. B65G 59/10; B65H 3/32; B65G 59/02

(52) U.S. Cl. 294/55.5

(57) ABSTRACT

Disclosed is a separator devised to separate packaging sheets that are stacked on top of each other and are each provided with cavities embossed therein, the cavities of each packaging sheet being arranged in multiple rows of a given length and fitting into the cavities of neighbouring packaging sheets that are stacked therewith. This separator basically comprises a handle to which are attached at least two rigid blades which are parallel to each other and each provided with a bevelled end opposite to the handle in order to be easily insertable between two stacked packaging sheets in order to facilitate their separation. The blades are spaced in such a manner as to be displaceable between two parallel rows of cavities in order to separate those of the packaging sheet under which the blades are inserted from those of the neighbouring packaging sheet located thereunder. Such facilitates the requested separation with risk of damaging the packaging sheets.

The present invention relates to a separator for packaging sheets provided with embossed cavities.

Within the context of the present invention, the expression “separator for packaging sheets” means a tool specially devised for separating packaging sheets that are stacked on each other and are each provided with cavities embossed therein, the cavities of each packaging sheet being of a given height and being arranged in multiple rows of a given length in a manner as to fit into the cavities of neighbouring packaging sheets that are stacked therewith.

Packaging sheets provided with cavities and devised so as to be stacked one above the other for transportation and storage are well known as such and used in several fields, especially in the pharmaceutical field for storing pills or drugs. By way of example, reference can be made to the packaging sheets also called “pill containers” and “container-defining sheets” that are described in the following U.S. patents filed with designation of the same inventor as the present invention: U.S. Pat. No. 5,788,079; U.S. Pat. No. 6,021,623; U.S. Pat. No. 6,023,916; U.S. Pat. No. 6,026,726; U.S. Pat. No. 6,382,420 and U.S. Pat. No. 7,308,984.

The packaging sheets disclosed in these patents are usually delivered in pharmacy in order to allow the storage of drugs to be administered at a given date and/or a given hour in each of the cavities, with a sheet indicating the given date and hour, the name of the drug and any other information regarding the administration of it.

In order to facilitate the transportation and storage of the packaging sheets, it is of common practice to stack them one above the other after their manufacture.

Of course, when use is made of them, the packaging sheets must be separated one after the other, which is sometimes difficult because of the stacking of the cavities of the different packaging sheets into each other.

The object of the present invention is a separator especially devised to separate packaging sheets that are stacked on top of each other. It is worth mentioning here that this separator is not exclusively intended to be used for separating packaging sheets whose cavities are intended to receive pills or other drugs. This separator could actually be used with any other kind of packaging sheets provided cavities that are devised to receive elements and are positioned in such a manner as to be stacked each other for storage and/or transportation.

So, the object of the present invention is more precisely a separator for packaging sheets provided with cavities embossed therein, the cavities of each packaging sheet being arranged in multiple rows of a given length and fitting into the cavities of neighbouring packaging sheets that are stacked therewith. This separator basically comprises a handle to which are attached at least two rigid blades which are parallel to each other and each provided with a bevelled end opposite to the handle in order to be easily insertable between two stacked packaging sheets in order to facilitate their separation, said blades being spaced in such a manner as to be displaceable between two parallel rows of cavities in order to separate those of the packaging sheet under which the blades are inserted from those of the neighbouring packaging sheet located thereunder.

Preferably, the blades are of substantially a same height as the cavities and have a length substantially equal or longer than those than the rows between which they are intended to be inserted. Such, substantially facilitates the separation.

Preferably also, each of the blades has an upper edge and the separator further comprises a transversal bar which is attached to the upper edges of the blades at a given distance from the handle in order to retain said blades in parallel relationship at said given distance from the handle.

It is worth mentioning that the number of blades may vary. In practice, it is necessary to have at least two of them. Indeed, the presence of two blades gives to the separator a good stability during insertion and minimized the risk of unvoided stretching or tearing of one or more cavities. However, when the packaging sheets have several rows of cavities, the separator may comprise more than two blades.

In practice, the separator can be made of molded plastic. However, it could be is made of any other material, provided of course of its structure be as described hereinabove.

The invention and its advantages will be better understood upon reading the following non-restrictive description of several preferred embodiments thereof, made with reference to the accompanying drawings wherein:

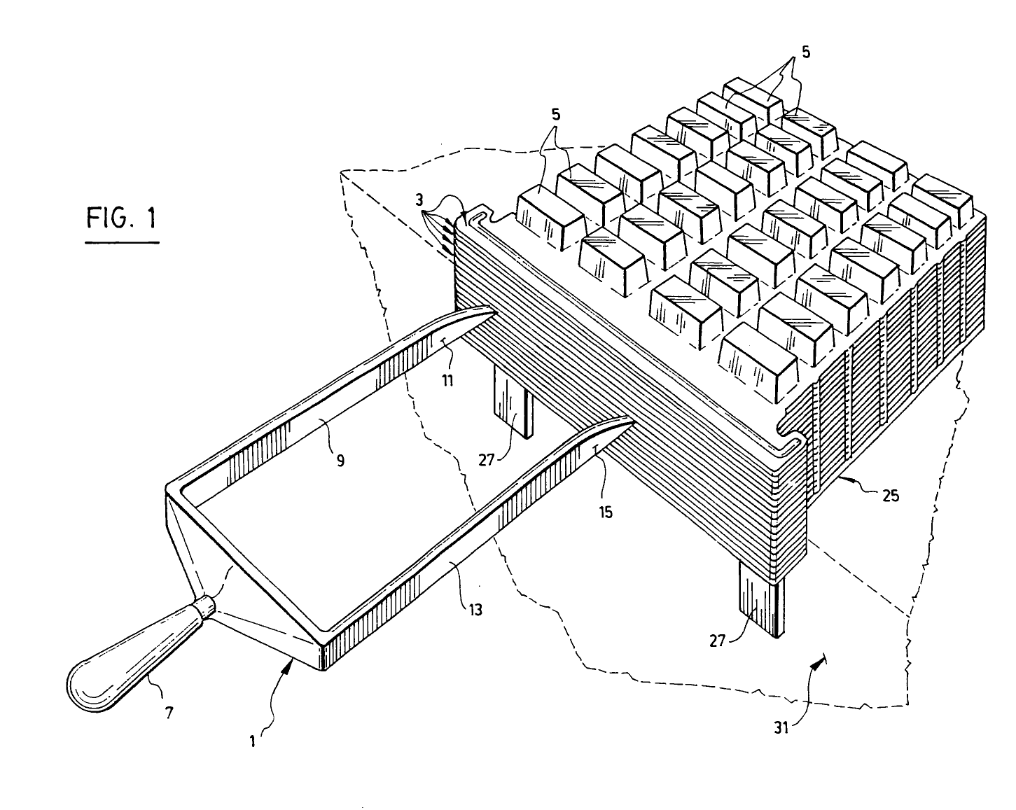

FIG. 1 is a perspective view of a separator according to the invention, provided with two blades, and ready to be used for separating the packaging sheet on top of a group of packaging sheets stacked one above the other and each provided with cavities embossed therein;

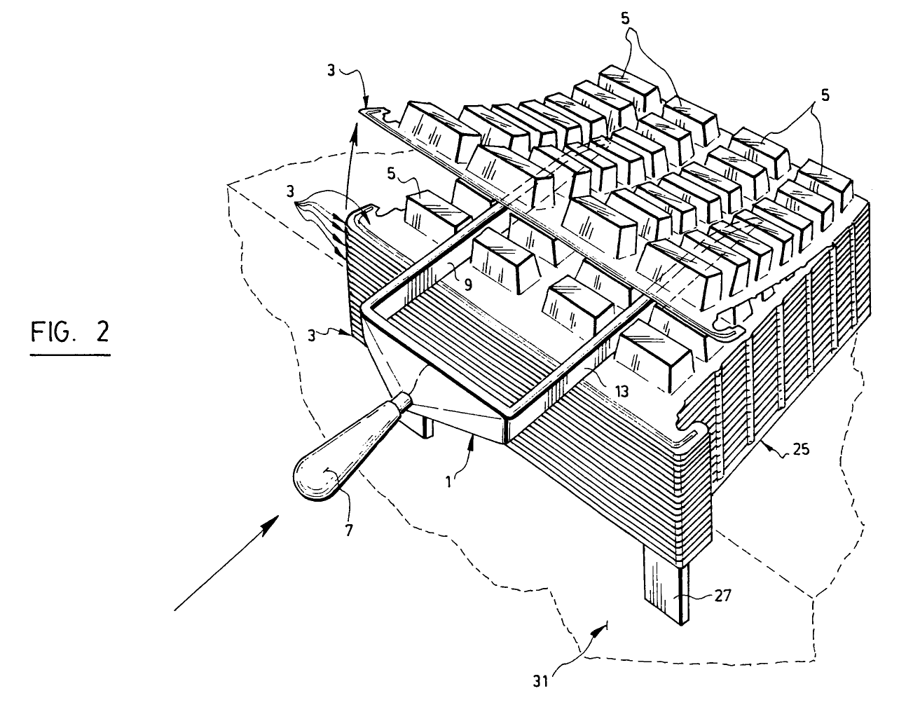

FIG. 2 is a view similar to FIG. 1, showing the separation that is obtained when the separator is moved forward;

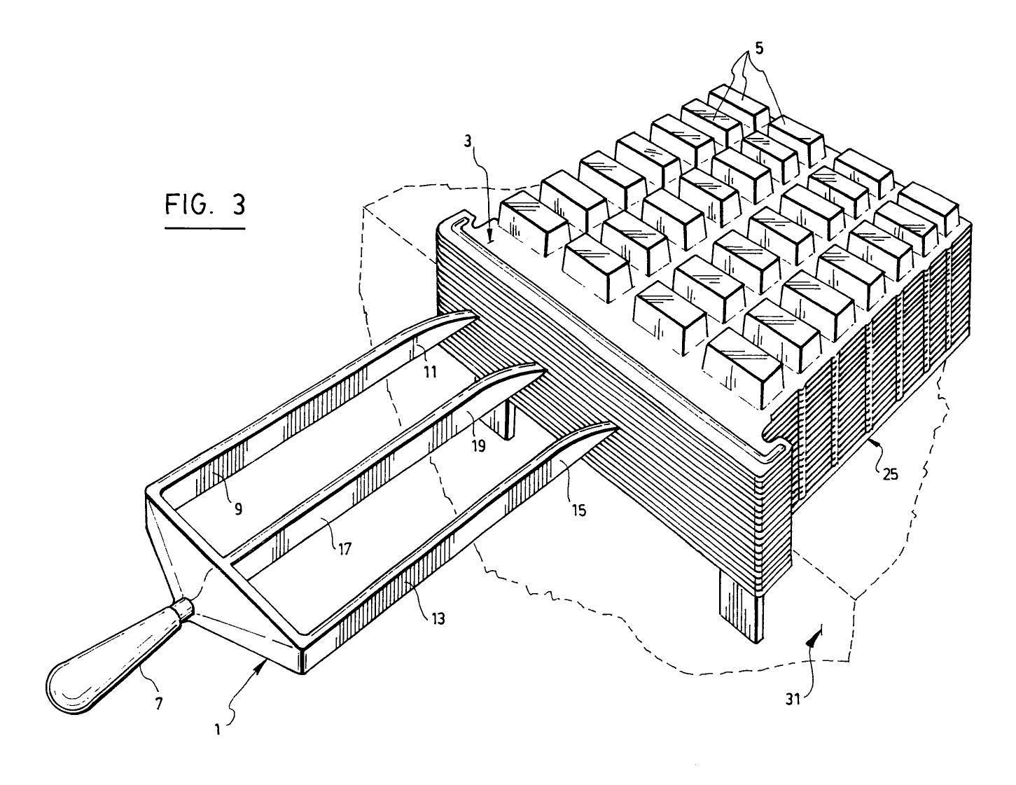

FIG. 3 is a view similar to FIG. 1, showing a separator intended to be used for separating the same kind of packaging sheets, but which is provided with three blades instead of two;

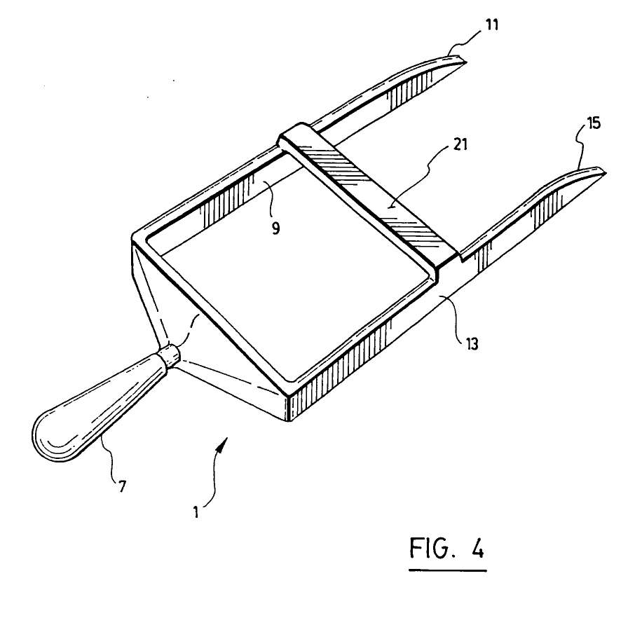

FIG. 4 is a view of a variant of the separator shown in FIG. 1, the variant lying in the presence of a transversal bar fixed to the upper edges of both of the blades at a given distance from the handle;

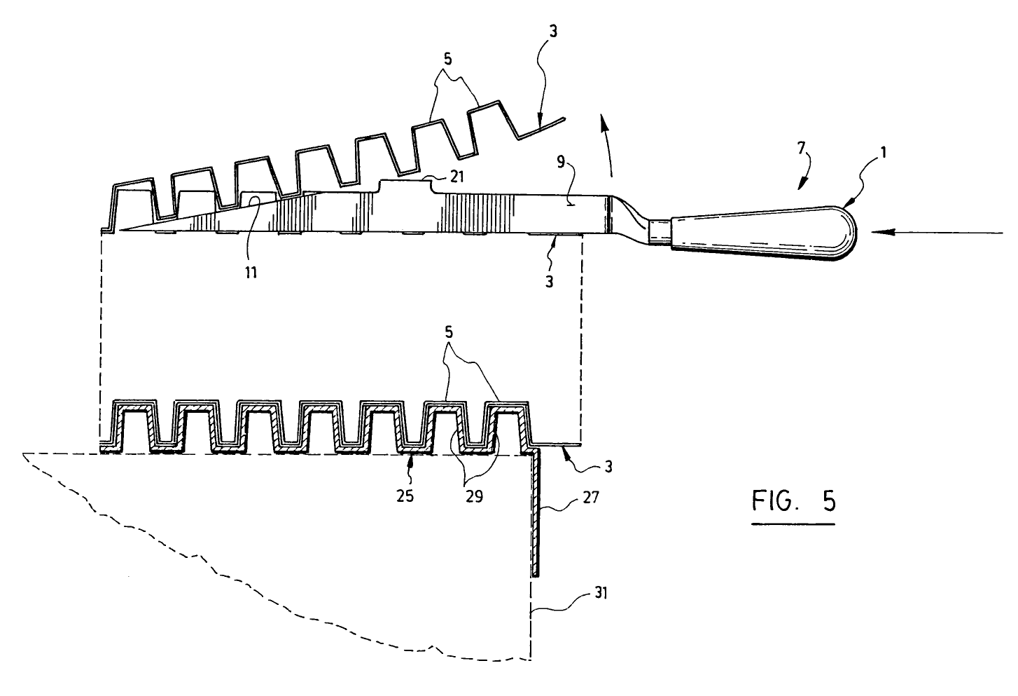

FIG. 5 is a side elevational view showing the way the separator shown in FIG. 4 operates in use and causes separation of the packaging sheets stacked to each other; and

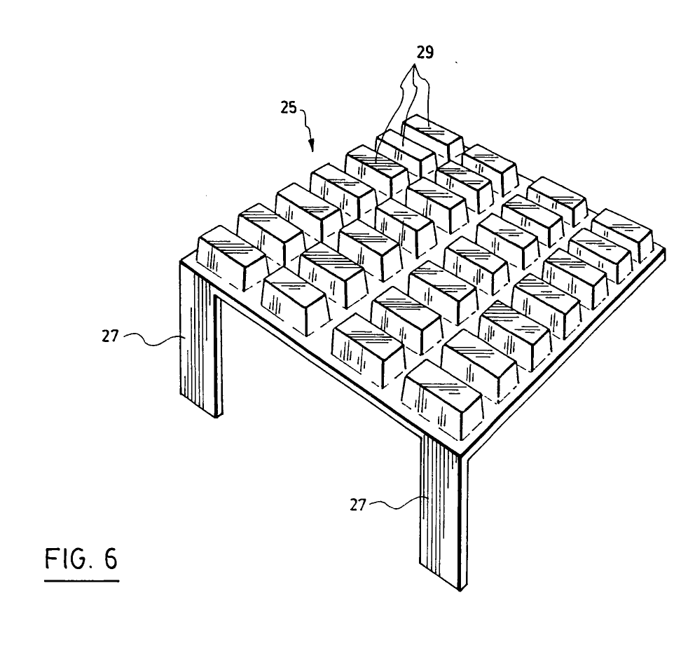

FIG. 6 is a perspective view of a support made of rigid material, on which the group of packaging sheets to be separated can be installed, said support permitting to retain the packaging sheets against the edge of a table while the separator is moved forwards without having to hold and retain the group of packaging sheets by hand.

The separator 1 according to the different embodiments of the invention shown in the accompanying drawings, is intended to be used to separate packaging sheets 3 which are stacked onto each other and are each provided with cavities 5 of a given height that are themselves arranged in multiple rows of a given length so as to fit into the cavities of the neighbouring packaging sheets that are stacked therewith. For more details as to the structure and use of this kind of packaging sheets, reference can be made again to the U.S. patents listed hereinabove in the preamble of the description.

In the embodiment shown in FIGS. 1 and 2, the separator 1 comprises an handle 7 to which are attached two rigid blades 9 and 11 which are parallel to each other and each provided with bevelled ends 11 and 15 in order to be inserted between two of the packaging sheets that are stacked onto each other in order to facilitate their separation as it is better shown in FIG. 2.

Of course, to achieve such a separation without tearing the cavities 5, the blades 9 and 13 are spaced apart in such a manner as to be displaceable between two parallel rows of cavities 5 in order to separate those of the packaging sheets under which the blades are inserted from those of the packaging sheets that are located just under it, as it is again shown in FIGS. 1 and 2 of the drawings.

In another embodiment of the invention shown in FIG. 3, the separator 1 comprises three blades 9, 13 and 17, the third blade 17 being located between the blades 9 and 13. It is worth noting that the separator could comprise even more than three blades depending on the number of rows of cavities that would be present into the packaging sheets 3. Of course, this supplemental blade 17 has also a front end 19 which is bevelled in the same way as ends 11 and 15 of the blades 9 and 13, in order to facilitate its insertion between the packaging sheets to be separated.

According to another embodiment of the invention shown in FIG. 4, the separator 1 further comprises a transversal bar 21 which extends between the upper edges of the blades 9 and 13 at a given distance from the handle 7 in order to retain the blades in parallel relationship while preventing said blades from moving apart and/or being deformed in use.

It is worth noting that in all cases, even though this is not actually compulsory, the blades advantageously have a height substantially equal to those of the cavities 5 and a length substantially equal or longer than the length of the rows in which there are intended to be inserted. Indeed, such facilitates their insertion under the packaging sheet to be separated from the others without risk of hitting and damaging the cavities 5 of these packaging sheets. This separating efficiency is clearly illustrated in FIG. 5.

The separator 1 according to the invention is preferably made of molded plastic.

However, it could be made of any other material. Similarly, the packaging sheets 3 provided with cavities can be made of plastic material. These packaging sheets 3 can be of the type used to receive pills or any other drug. The separator according to the invention could however be used with other kinds of packaging sheets provided with cavities in order to separate them when they are stacked one into each other.

In order to provide a proper retaining of the group of packaging sheets that was stacked into each other and are to be separated onto a table on which they are located, a support 25 made of rigid material such as plastic material or metal, can also be provided and installed close to the edge 31 of the table. The support 25 which is shown in FIG. 6, comprises one or more front legs 27, the purpose of which is to stay onto the edge 31 of the table on which the packaging sheets are located. The support 25 also comprises projections 29 devised to receive the cavities 5 of the packaging sheets and thus ensure proper stacking of the group of packaging sheets to be separated. The support 25 is illustrated in use in FIGS. 1 to 3 of the drawings. Its positioning under the group of packaging sheets is also illustrated in FIG. 5.

As mentioned hereinabove, the present invention has the advantage of solving the problem mentioned hereinabove, namely the difficulties as may sometimes have the users of packaging sheets to separate these packaging sheets from a group of them where all the cavities are fitted to each other. With the separator according to the invention, one may therefore separate each of the packaging sheets in a very simple manner without risk of damaging the same.

Of course, numerous modifications could be made to the present invention without departing from the scope of the invention as defined in the appended claims.

1. A tool hereinafter called <<a separator>> for separating packaging sheets which are stacked on top of each other and are each provided with cavities embossed therein, the cavities of each packaging sheet being arranged in multiple rows of a given length and fitting into the cavities of neighbouring packaging sheets that are stacked therewith,
wherein said separator comprises a handle to which are attached at least two rigid blades which are parallel to each other and each provided with a bevelled end opposite to the handle in order to be easily insertable between two stacked packaging sheets in order to facilitate their separation, said blades being spaced in such a manner as to be displaceable between two parallel rows of cavities in order to separate those of the packaging sheet under which the blades are inserted from those of the neighbouring packaging sheet located thereunder.

2. The separator according to claim 1, wherein the blades are of substantially a same height as the cavities and have a length substantially equal or longer than those than the rows between which they are intended to be inserted.

3. The separator according to claim 2, wherein each of the blades has an upper edge and said separator further comprises a transversal bar which is attached to the upper edges of the blades at a given distance from the handle in order to retain said blades in parallel relationship at said given distance from the handle.

4. The separator according to claim 1, wherein said separator comprises only two blades.

5. The separator according to claim 1, wherein said separator comprises three blades.

6. The separator according to claim 1, wherein said separator is made of molded plastic.

7. The separator according to claim 1, wherein the packaging sheets are made of plastic material and have their cavities devised to receive pills or other drugs.

8. The separator according to claim 2, wherein said separator comprises only two blades.

9. The separator according to claim 2, wherein said separator comprises three blades.

10. The separator according to claim 2, wherein said separator is made of molded plastic.

11. The separator according to claim 3, wherein said separator comprises only two blades.

12. The separator according to claim 3, wherein said separator comprises three blades.

13. The separator according to claim 3, wherein said separator is made of molded plastic.

14. The separator according to claim 10, wherein the packaging sheets are made of plastic material and have their cavities devised to receive pills or other drugs.

15. The separator according to claim 13, wherein the packaging sheets are made of plastic material and have their cavities devised to receive pills or other drugs.
